(19) United States
(12) Patent Application Publication
(10) Pub. No.: US 2011/0169416 A1
(43) Pub. Date: Jul. 14, 2011

(54) DISCONTINUOUS CURRENT REGULATOR CIRCUIT FOR DRIVING LIGHT-EMITTING DIODES

(75) Inventor: Wen-Hsiung Hsieh, Keelung (TW)

(73) Assignee: Wen-Hsiung Hsieh, Keelung (TW)

(21) Appl. No.: 12/684,945

(22) Filed: Jan. 10, 2010

(51) Int. Cl. H05B 37/02

(52) U.S. Cl. 315/219; 315/224

(57) ABSTRACT

A discontinuous current regulator circuit is composed of a switched-mode power converter circuit, a sensing circuit and a current mode controller circuit. The current mode controller circuit, based on the signal from the sensing circuit, controls the switched-mode power converter circuit to supply a regulated discontinuous current to a light-emitting diode or light-emitting diode arrangement comprising a plurality of light-emitting diodes. The present invention provides a discontinuous current regulator circuit for driving white light-emitting diodes able to provide higher perceived brightness levels and with longer lifetime than existing light-emitting diode drivers.

### TECHNICAL FIELD

The technical field of this disclosure is current regulator circuits, particularly, a discontinuous current regulator circuit for supplying a discontinuous current to at least one light-emitting diode.

### BACKGROUND OF THE INVENTION

Significant advances have been made in the technology of white light-emitting diodes. White light-emitting diodes are commercially available which generate 60˜100 lumens/watt. This is comparable to the performance of fluorescent lamps; therefore there have been a lot of applications in the field of lighting using white light-emitting diodes.

Various light-emitting diode driver circuits are known from the prior arts. For example, U.S. Pat. No. 6,304,464: “FLYBACK AS LED DRIVER”; U.S. Pat. No. 6,577,512: “POWER SUPPLY FOR LEDS”; and U.S. Pat. No. 6,747,420: “DRIVER CIRCUIT FOR LIGHT-EMITTING DIODES”. All the light-emitting diode driver circuits mentioned above are constant current regulator circuits that act as const current sources to drive light-emitting diodes.

In the field of lighting applications, for a white light-emitting diode lamp driven by a constant current source and a fluorescent lamp driven by an alternating current source under the condition that both lamps' remitted illumination have the same average illumination value, the fluorescent lamp provides higher perceived brightness levels than the white light-emitting diode lamp, the reason is: human eyes are responsive to the peak value of illumination; therefore, if a lamp can provide higher peak illumination, it provides higher perceived brightness levels. For a fluorescent lamp driven by an alternating current source, it remits illumination with peak value higher than its average illumination value. But for a white light-emitting diode lamp driven by a constant current source, since light generation of a white light-emitting diode is dependent on the current strength through the white light-emitting diode, it remits illumination with peak value close to its average illumination value. Therefore, a white light-emitting diode lamp driven by a constant current regulator circuit constitutes a drawback of its remitted illumination with low perceived brightness levels.

In addition, for a constant current regulator circuit with flyback type topology, including boost; buck-boost; nonisolated flyback or isolated flyback converter topology, a large enough capacitance is needed in its output filter circuit to supply a constant current continuously during the period when its semiconductor switching element is closed. Thus generally at least one aluminum electrolytic capacitor is used to fulfill the requirement of a large enough capacitance. However, since lifetime of a white light-emitting diode is usually more than 20,000 average life hours, but lifetime of an aluminum electrolytic capacitor is usually from 1,000 to 5,000 average life hours only. Thus this constitutes a drawback of limited lifetime in the field of lighting applications due to the usage of aluminum electrolytic capacitors.

It would be desirable to have a light-emitting diode driving circuit that would overcome the above disadvantages.

### SUMMARY OF THE INVENTION

One aspect of the present invention provides a discontinuous current regulator circuit for driving white light-emitting diodes able to provide higher perceived brightness levels than existing light-emitting diode driving circuit based on a constant current regulator circuit.

Accordingly, a white light-emitting diode can be driven by a discontinuous current with peak current value higher than its maximum constant current rating or driven by a constant current equal to its maximum constant current rating. Since light generation of a white light-emitting diode is dependent on the current strength through the white light-emitting diode, to drive a white light-emitting diode with a discontinuous current with peak current value higher than its maximum constant current rating can remit illumination with higher peak illumination value to provide higher perceived brightness levels than to drive it with a constant current equal to its maximum constant current rating.

Another aspect of the present invention provides a discontinuous current regulator circuit for driving light-emitting diodes having longer lifetime than existing light-emitting diode drivers: since the present invention provides a discontinuous current regulator circuit with flyback type topology that don't have to keep on supplying current to its output during the period when its semiconductor switching element is closed, therefore the usage of aluminum electrolytic capacitors to keep on supplying current to its output is not needed.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention.

### BRIEF DESCRIPTION OF THE DRAWINGS

FIG. 1 shows a block and circuit diagram of a circuit which constitutes a first exemplary embodiment of a discontinuous current regulator circuit with buck converter topology according to the invention.

FIG. 2 shows a block and circuit diagram of a circuit which constitutes a second exemplary embodiment of a discontinuous current regulator circuit with boost converter topology according to the invention.

FIG. 3 shows a block and circuit diagram of a circuit which constitutes a third exemplary embodiment of a discontinuous current regulator circuit with buck-boost converter topology according to the invention.

FIG. 4 shows a block and circuit diagram of a circuit which constitutes a fourth exemplary embodiment of a discontinuous current regulator circuit with nonisolated flyback converter topology according to the invention.

FIG. 5 shows a block and circuit diagram of a circuit which constitutes a fifth exemplary embodiment of a discontinuous current regulator circuit with isolated flyback converter topology according to the invention.

FIG. 6 shows a block and circuit diagram of a circuit which constitutes a sixth exemplary embodiment of a discontinuous current regulator circuit with forward converter topology according to the invention.

### DETAILED DESCRIPTION OF THE PREFERRED EMBODIMENTS

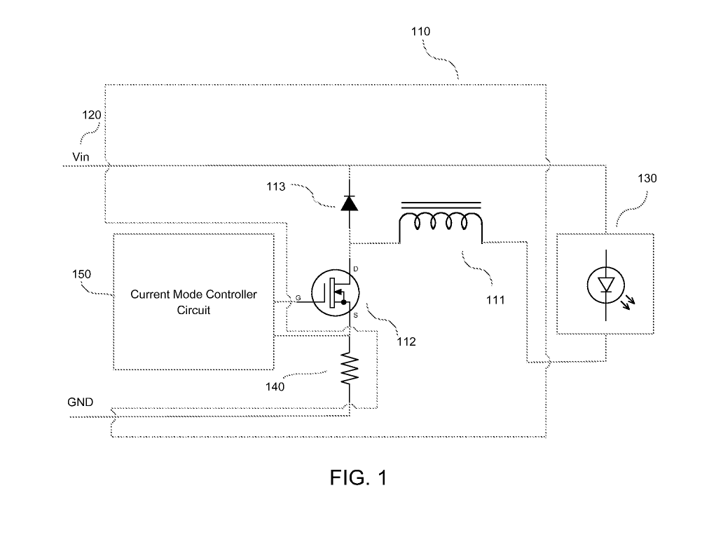

FIG. 1 shows a block and circuit diagram of a circuit which constitutes a first exemplary embodiment of a discontinuous current regulator circuit with buck converter topology according to the invention.

The circuit shown in FIG. 1 essentially comprises a switched-mode power converter circuit with buck converter topology 110, a sensing circuit 140, a current mode controller circuit 150, and a light-emitting diode or light-emitting diode arrangement comprising a plurality of light-emitting diodes 130.

The switched-mode power converter circuit 110 comprises a power inductor 111, a semiconductor switching element 112, and a diode 113, wherein the switched-mode power converter circuit 110 has input means for receiving a direct voltage Vin 120 and output means coupled to the light-emitting diodes 130.

In the case of the first exemplary embodiment shown in FIG. 1, the sensing circuit 140 in the form of an ohmic resistor is connected in series with the semiconductor switching element 112. To regulate a discontinuous current supplied to the light-emitting diodes 130, the voltage drop across the sensing circuit 140 is determined and fed to the current mode controller circuit 150 as a measured signal representing the current through the power inductor 111 while the semiconductor switching element 112 is closed. The current mode controller circuit 150 controls the switching of the semiconductor switching element 112 dependent on the current through the power inductor 111. Wherein the semiconductor switching element 112 is switched on and off continuously: during the period when the semiconductor switching element 112 is closed, energy from the direct voltage Vin 120 is received for storing energy into the power inductor 111 and supplying current to the light-emitting diodes 130; during the period when the semiconductor switching element 112 is opened, the previously stored energy in the power inductor 111 is released for supplying current to the light-emitting diodes 130. To operate the switched-mode power converter circuit 110 under discontinuous conduction mode, then during the period when the semiconductor switching element 112 is opened the current through the power inductor 111 decreases to a value of zero. During the period when the current through the power inductor 111 is zero, there is no current fed to the light-emitting diodes 130. The current mode controller circuit 150 controls the switching of the semiconductor switching element 112 dependent on the current through the power inductor 111, the discontinuous current supplied from the power inductor 111 to the light-emitting diodes 130 is regulated accordingly.

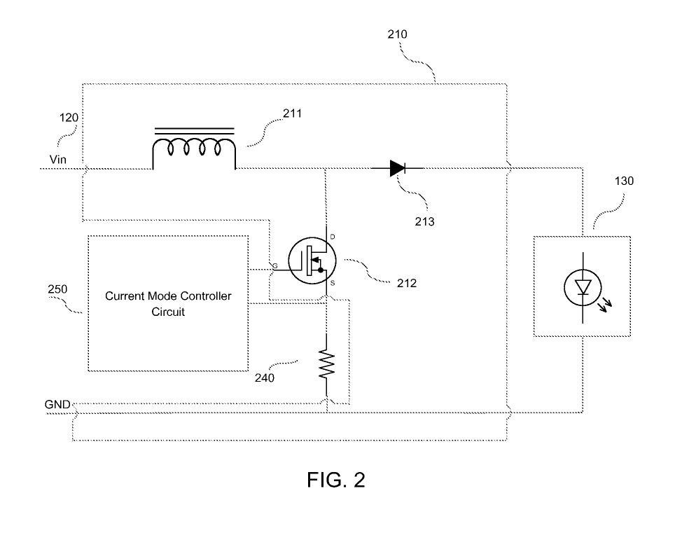

FIG. 2 shows a block and circuit diagram of a circuit which constitutes a second exemplary embodiment of a discontinuous current regulator circuit with boost converter topology according to the invention.

The circuit shown in FIG. 2 essentially comprises a switched-mode power converter circuit with boost converter topology 210, a sensing circuit 240, a current mode controller circuit 250, and a light-emitting diode or light-emitting diode arrangement comprising a plurality of light-emitting diodes 130.

The switched-mode power converter circuit 210 comprises a power inductor 211, a semiconductor switching element 212, and a diode 213, wherein the switched-mode power converter circuit 210 has input means for receiving a direct voltage Vin 120 and output means coupled to the light-emitting diodes 130.

In the case of the second exemplary embodiment shown in FIG. 2, the sensing circuit 240 in the form of an ohmic resistor is connected in series with the semiconductor switching element 212. To regulate a discontinuous current supplied to the light-emitting diodes 130, the voltage drop across the sensing circuit 240 is determined and fed to the current mode controller circuit 250 as a measured signal representing the current through the power inductor 211 while the semiconductor switching element 212 is closed. The current mode controller circuit 250 controls the switching of the semiconductor switching element 212 dependent on the current through the power inductor 211. Wherein the semiconductor switching element 212 is switched on and off continuously: during the period when the semiconductor switching element 212 is closed, energy from the direct voltage Vin 120 is stored into the power inductor 211 and since the diode 213 is reverse biased, there is no current fed to the light-emitting diodes 130; during the period when the semiconductor switching element 212 is opened, previously stored energy in the power inductor 211 is released and combined with energy supplied from the direct voltage Vin 120 to supply current to the light-emitting diodes 130. The current mode controller circuit 250 controls the switching of the semiconductor switching element 212 dependent on the current through the power inductor 211, thus the discontinuous current supplied from the power inductor 211 to the light-emitting diodes 130 is regulated accordingly.

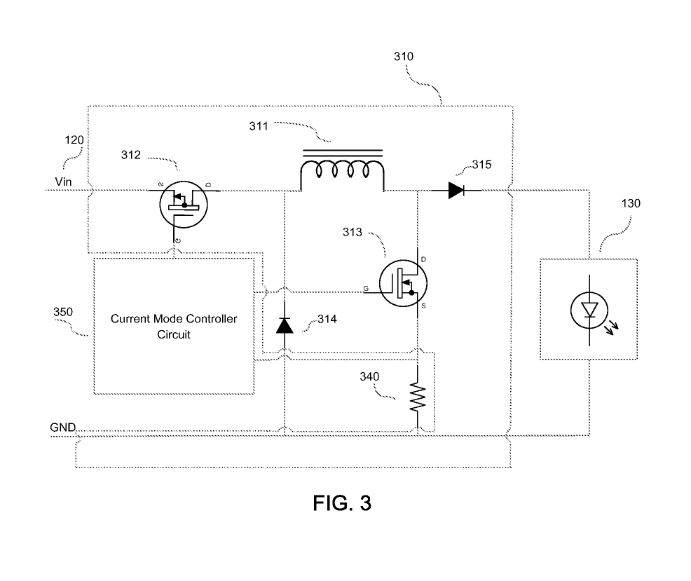

FIG. 3 shows a block and circuit diagram of a circuit which constitutes a third exemplary embodiment of a discontinuous current regulator circuit with buck-boost converter topology according to the invention.

The circuit shown in FIG. 3 essentially comprises a switched-mode power converter circuit with buck-boost converter topology 310, a sensing circuit 340, a current mode controller circuit 350, and a light-emitting diode or light-emitting diode arrangement comprising a plurality of light-emitting diodes 130.

The switched-mode power converter 310 comprises a power inductor 311, two semiconductor switching elements 312 and 313, and two diodes 314 and 315, wherein the switched-mode power converter circuit 310 has input means for receiving a direct voltage Vin 120 and output means coupled to the light-emitting diodes 130.

In the case of the third exemplary embodiment shown in FIG. 3, the sensing circuit 340 in the form of an ohmic resistor is connected in series with the semiconductor switching element 313. To regulate a discontinuous current supplied to the light-emitting diodes 130, the voltage drop across the sensing circuit 340 is determined and fed to the current mode controller circuit 350 as a measured signal representing current through the power inductor 311 while the semiconductor switching elements 312 and 313 are closed. The current mode controller circuit 350 controls the switching of the semiconductor switching elements 312 and 313 dependent on the current through the power inductor 311. Wherein the semiconductor switching elements 312 and 313 are simultaneously switched on and off continuously: during the period when the semiconductor switching elements 312 and 313 are closed, energy from the direct voltage Vin 120 is stored into the power inductor 311 and there is no current fed to the light-emitting diodes 130 since the diode 315 is reverse biased; during the period when the semiconductor switching element 312 and 313 are opened, previously stored energy in the power inductor 311 is released for supplying current to the light-emitting diodes 130. The current mode controller circuit 350 controls the switching of the semiconductor switching elements 312 and 313 dependent on the current through the power inductor 311, thus the discontinuous current supplied from the power inductor 311 to the light-emitting diodes 130 is regulated accordingly.

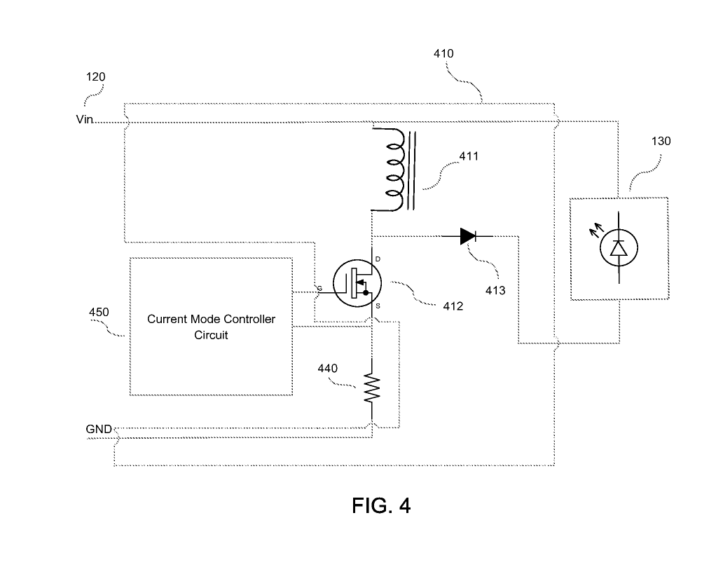

FIG. 4 shows a block and circuit diagram of a circuit which constitutes a fourth exemplary embodiment of a discontinuous current regulator circuit with nonisolated flyback converter topology according to the invention.

The circuit shown in FIG. 4 essentially comprises a switched-mode power converter circuit with nonisolated flyback converter topology 410, a sensing circuit 440, a current mode controller circuit 450, and a light-emitting diode or light-emitting diode arrangement comprising a plurality of light-emitting diodes 130.

The switched-mode power converter 410 comprises a power inductor 411, a semiconductor switching element 412, and a diode 413, wherein the switched-mode power converter circuit 410 has input means for receiving a direct voltage Vin 120 and output means coupled to the light-emitting diodes 130.

In the case of the fourth exemplary embodiment shown in FIG. 4, the sensing circuit 440 in the form of an ohmic resistor is connected in series with the semiconductor switching element 412. To regulate a discontinuous current supplied to the light-emitting diodes 130, the voltage drop across the sensing circuit 440 is determined and fed to the current mode controller circuit 450 as a measured signal representing current through the power inductor 411 while the semiconductor switching element 412 is closed. The current mode controller circuit 450 controls the switching of the semiconductor switching element 412 dependent on the current through the power inductor 411. Wherein the semiconductor switching element 412 is switched on and off continuously: during the period when the semiconductor switching elements 412 is closed, energy from the direct voltage Vin 120 is stored into the power inductor 411 and there is no current fed to the light-emitting diodes 130 since the diode 413 is reverse biased; during the period when the semiconductor switching element 412 is opened, previously stored energy in the power inductor 411 is released for supplying current to the light-emitting diodes 130. The current mode controller circuit 450 controls the switching of the semiconductor switching elements 412 dependent on the current through the power inductor 411, thus the discontinuous current supplied from the power inductor 411 to the light-emitting diodes 130 is regulated accordingly.

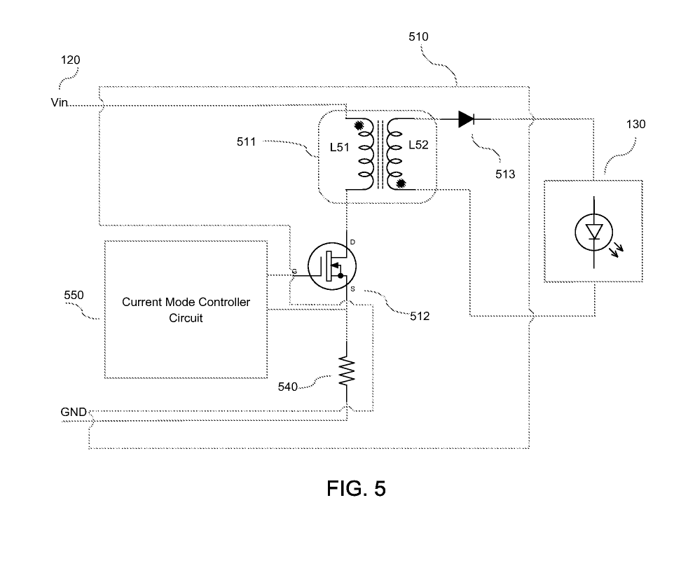

FIG. 5 shows a block and circuit diagram of a circuit which constitutes a fifth exemplary embodiment of a discontinuous current regulator circuit with isolated flyback converter topology according to the invention.

The circuit shown in FIG. 5 essentially comprises a switched-mode power converter circuit with isolated flyback converter topology 510, a sensing circuit 540, a current mode controller circuit 550, and a light-emitting diode or light-emitting diode arrangement comprising a plurality of light-emitting diodes 130.

The switched-mode power converter 510 comprises a transformer 511 provided with a primary winding L51 and a secondary winding L52, a semiconductor switching element 512, and a diode 513, wherein the switched-mode power converter circuit 510 has input means for receiving a direct voltage Vin 120 and output means coupled to the light-emitting diodes 130.

In the case of the fifth exemplary embodiment shown in FIG. 5, the sensing circuit 540 in the form of an ohmic resistor is connected in series with the semiconductor switching element 512. To regulate a discontinuous current supplied to the light-emitting diodes 130, the voltage drop across the sensing circuit 540 is determined and fed to the current mode controller circuit 550 as a measured signal representing current through the primary winding L51 of the transformer 511 while the semiconductor switching element 512 is closed. The current mode controller circuit 550 controls the switching of the semiconductor switching element 512 dependent on the current through the primary winding L51 of the transformer 511. Wherein the semiconductor switching element 512 is switched on and off continuously: during the period when the semiconductor switching elements 512 is closed, energy from the direct voltage Vin 120 is stored into the transformer 511 and there is no current fed to the light-emitting diodes 130 since the diode 513 is reverse biased; during the period when the semiconductor switching element 512 is opened, previously stored energy in the transformer 511 is released for supplying current to the light-emitting diodes 130. The current mode controller circuit 550 controls the switching of the semiconductor switching elements 512 dependent on the current through the primary winding L51 of the transformer 511, thus the discontinuous current supplied from the transformer 511 to the light-emitting diodes 130 is regulated accordingly.

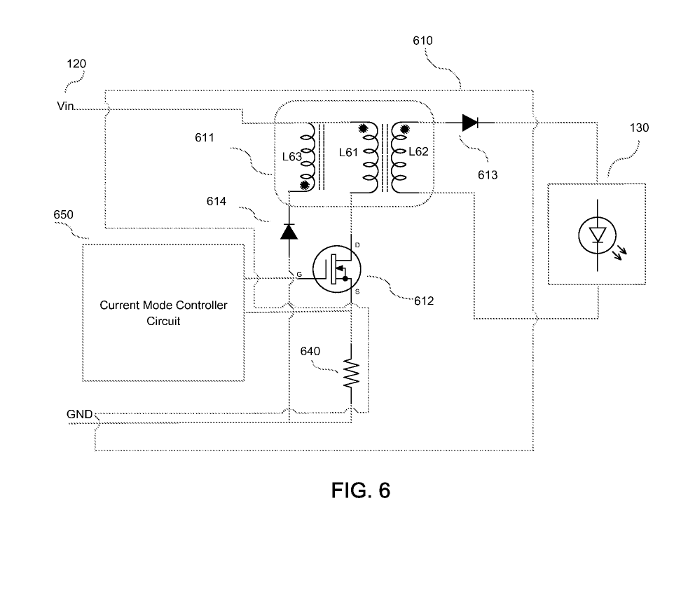

FIG. 6 shows a block and circuit diagram of a circuit which constitutes a sixth exemplary embodiment of a discontinuous current regulator circuit with forward converter topology according to the invention.

The circuit shown in FIG. 6 essentially comprises a switched-mode power converter circuit with forward converter topology 610, a sensing circuit 640, a current mode controller circuit 650, and a light-emitting diode or light-emitting diode arrangement comprising a plurality of light-emitting diodes 130.

The switched-mode power converter 610 comprises a transformer 611 provided with a primary winding L61, a secondary winding L62 and a clamp winding L63, a semiconductor switching element 612, and two diodes 613 and 614, wherein the switched-mode power converter circuit 610 has input means for receiving a direct voltage Vin 120 and output means coupled to the light-emitting diodes 130.

In the case of the sixth exemplary embodiment shown in FIG. 6, the sensing circuit 640 in the form of an ohmic resistor is connected in series with the semiconductor switching element 612. To regulate a discontinuous current supplied to the light-emitting diodes 130, the voltage drop across the sensing circuit 640 is determined and fed to the current mode controller circuit 650 as a measured signal representing current through the primary winding L61 of the transformer 611 while the semiconductor switching element 612 is closed. The current mode controller circuit 650 controls the switching of the semiconductor switching element 612 dependent on the current through the primary winding L61 of the transformer 611. Wherein the semiconductor switching element 612 is switched on and off continuously: during the period when the semiconductor switching elements 612 is closed, energy from the direct voltage Vin 120 is transferred from the primary winding L61 to the secondary winding L62 for supplying current to the light-emitting diodes 130; during the period when the semiconductor switching element 612 is opened, there is no current fed to the light-emitting diodes 130. The current mode controller circuit 650 controls the switching of the semiconductor switching elements 612 dependent on the current through the primary winding L61 of the transformer 611, thus the discontinuous current supplied from the transformer 611 to the light-emitting diodes 130 is regulated accordingly.

It is to be understood that the above described embodiments are merely illustrative of the principles of the invention and that other arrangements may be devised by those skilled in the art without departing from the spirit and scope of the invention.

What is claimed is:

1. A circuit for supplying a discontinuous current to at least one light-emitting diode, said circuit comprising:
a switched-mode power converter circuit having input means for receiving a direct voltage and output means coupled to said at least one light-emitting diode, said switched-mode power converter circuit including a magnetic storage element connected to at least one semiconductor switching element;
a sensing circuit for sensing current of said magnetic storage element;
a current mode controller circuit having an input coupled to an output of said sensing circuit and at least one output coupled to said at least one semiconductor switching element, for controlling said at least one semiconductor switching element to regulate a discontinuous current supplied from said switched-mode power converter circuit to said at least one light-emitting diode.

2. The circuit according to claim 1, wherein the magnetic storage element is an inductor.

3. The circuit according to claim 1, wherein the magnetic storage element is a transformer.

4. The circuit according to claim 1, wherein the current mode controller circuit and said at least one semiconductor switching element is configured into a sole integrated circuit.

5. The circuit according to claim 1, wherein the current mode controller circuit and the sensing circuit is configured into a sole integrated circuit.

6. The circuit according to claim 1, wherein the current mode controller circuit and the sensing circuit and said at least one semiconductor switching element is configured into a sole integrated circuit.

7. The circuit according to claim 1, wherein the switched-mode power converter circuit is a power converter circuit with buck converter topology.

8. The circuit according to claim 1, wherein the switched-mode power converter circuit is a power converter circuit with boost converter topology.

9. The circuit according to claim 1, wherein the switched-mode power converter circuit is a power converter circuit with buck-boost converter topology.

10. The circuit according to claim 1, wherein the switched-mode power converter circuit is a power converter circuit with nonisolated flyback converter topology.

11. The circuit according to claim 1, wherein the switched-mode power converter circuit is a power converter circuit with isolated flyback converter topology.

12. The circuit according to claim 1, wherein the switched-mode power converter circuit is a power converter circuit with forward converter topology.
